(19) United States
(12) Patent Application Publication
(10) Pub. No.: US 2008/0272267 A1
(43) Pub. Date: Nov. 6, 2008

(54) UNDER-COUNTER MOUNTING SYSTEM FOR A DISHWASHER, AND ASSOCIATED METHOD

(75) Inventors: Torkel Kristensson, Zirndorf (DE); Jerry Olesen, Kinston, NC (US); Van Beck, La Grange, NC (US); Ronald G. Tynes, Winterville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/028,268

(22) Filed: Feb. 8, 2008

Related U.S. Application Data
(60) Provisional application No. 60/916,113, filed on May 4, 2007.

(51) Int. Cl. F16M 1/00

(52) U.S. Cl. 248/675

(57) ABSTRACT

An under-counter mounting system and associated method are provided for mounting a dishwasher under a counter, without direct attachment to the counter. The mounting system comprises a pair of discrete bracket members each slidably received by a receiving member operably engaged with a dishwasher about a forward portion thereof, the receiving members being disposed in opposing lateral relation with respect to the forward portion of the dishwasher and configured such that the bracket members are laterally slidable between an inward position and an outward position, while being longitudinally constrained, wherein each bracket member further includes a longitudinally-extending flange disposed outwardly of the respective receiving member, and wherein the flange defines at least one fastening aperture adapted to facilitate securement of the bracket member to a laterally adjacent cabinet.

### CROSS-REFERENCE TO RELATED APPLICATIONS

This application claims the benefit of U.S. Provisional Application No. 60/916,113, filed May 4, 2007, the contents of which are incorporated herein by reference.

### BACKGROUND OF THE INVENTION

1. Field of the Invention

Embodiments of the present invention relate to dishwashers and, more particularly, to a mounting system for mounting a dishwasher under a countertop, and a method associated therewith.

2. Description of Related Art

A dishwasher is typically mounted in an under-counter arrangement in a space next to or between cabinets. More particularly, the dishwasher usually includes a bracket attached to the upper frame member and defining at least one fastening hole. When the dishwasher is moved into the cabinet space, a fastener such as a screw is inserted through the fastener hole and threaded into the underside of the countertop. In this manner, the bracket is generally hidden from view, and the dishwasher door can be opened and closed without interference from the bracket.

This typical securement system for a dishwasher is limited, however, by the type of material from which the countertop is made. Specifically, the countertop must be formed of a material capable of receiving the fastener without damaging the countertop or altering the aesthetics of the visible top surface of the countertop. Thus, such a top-mounting system may not effective where, for instance, the countertop comprises a hard, solid material, such as concrete or natural stone (e.g., granite or quartz). That is, the fastener for securing the dishwasher in the cabinet, via the bracket, may not be able to engage the solid countertop material and/or may risk damage to the countertop by insertion of the fastener. Accordingly, it would be desirable to have a system for mounting a dishwasher under a countertop, without attachment to the countertop itself.

### BRIEF SUMMARY OF THE INVENTION

Typically, cabinets supporting a countertop in a kitchen are often comprised of a relatively soft material, such as wood or a laminate. A dishwasher, when included in such a kitchen, is also typically configured to be mounted amongst the cabinets under the countertop. However, the dishwasher must also be secured within that mounting environment in order to complete the installation. In some instances, the countertop comprises a hard, solid material, such as concrete or natural stone (e.g., granite or quartz), to which it is often impractical to secure the dishwasher upon installation. As such, regardless of the countertop material, the cabinets formed of a relatively soft material provide a practical alternative to which the dishwasher may be secured upon installation.

As such, the above and other needs are met by the present invention which, in one aspect, provides an under-counter appliance mounting system, including a pair of discrete bracket members each configured to be slidably received by a receiving member operably engaged with an appliance about a forward portion thereof (i.e., to a frame surrounding the front opening of the tub). The receiving members are disposed in opposing lateral relation with respect to the forward portion of the appliance and are configured such that the bracket members are laterally slidable between an inward position and an outward position, while being longitudinally constrained. Each bracket member includes a longitudinally-extending flange disposed outwardly of the respective receiving member. The flange defines at least one fastening aperture and is adapted to facilitate securement of the bracket member to a laterally-adjacent vertical surface (i.e., a side of an adjacent cabinet) via the at least one fastening aperture.

Another aspect of the present invention provides a method for securing an appliance, under a countertop, to laterally-adjacent mounting surfaces, without direct attachment to the countertop. A bracket member is slidably received in each of a pair of discrete receiving members. The receiving members are operably engaged with an appliance about a forward portion thereof, and are disposed in opposing lateral relation with respect to the forward portion of the appliance, such that the bracket members are laterally slidable between an inward position and an outward position with respect thereto, while being longitudinally constrained. Each bracket member further includes a longitudinally-extending flange disposed outwardly of the respective receiving member. Each bracket member is then secured to the laterally-adjacent mounting surface by engaging the mounting surface, via at least one fastening aperture defined by the flange, with a fastener.

Aspects of the present invention therefore provide distinct advantages as otherwise detailed herein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a front perspective view of a dishwasher with an under-counter mounting system according to one embodiment of the present invention;

FIG. 2 is a magnified view of a mounting bracket slidably engaging a corner support according to one embodiment of an under-counter mounting system according to the present invention;

FIG. 3 is a front perspective view of a corner support according to one embodiment of the present invention;

FIG. 4 is a magnified view of a channel cover and friction device in one embodiment of a corner support according to the present invention;

FIG. 5 is a front perspective view of a corner support slidably receiving a mounting bracket according to one embodiment of the present invention;

FIG. 6 is a rear perspective view of a corner support according to one embodiment of the present invention;

FIG. 7 is magnified view of a mounting bracket according to one embodiment of the present invention; and

FIG. 8a-FIG. 8d illustrates pairs of mounting brackets in various mounting arrangements according to particular embodiments of the invention.

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

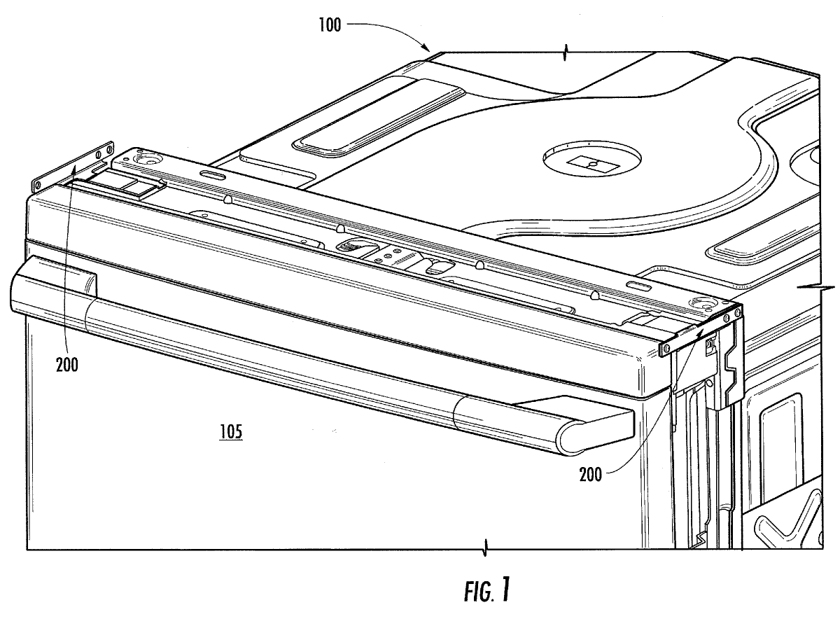

Embodiments of the present invention provide a fixation or securement system for mounting an appliance, such as a dishwasher, under a countertop, but without direct fixation to the countertop itself. Accordingly, embodiments of the present invention provide an under-counter mounting system comprising one or more mounting brackets (preferably a pair of discrete mounting brackets) having flanges for securement to a vertical surface, such as a side portion of a cabinet, that is laterally adjacent to the dishwasher. One embodiment of such an arrangement according to the invention, for use with a dishwasher, is shown in FIG. 1.

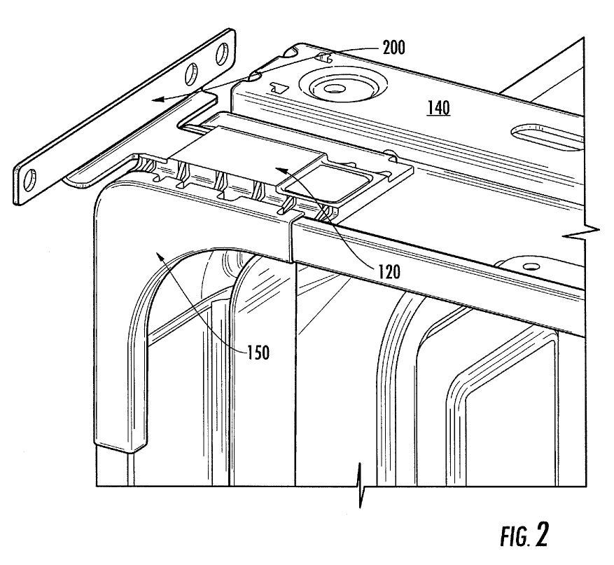

More particularly, FIG. 1 illustrates a dishwasher 100 comprising a pair of side mounting brackets 200 attached about a forward portion of the top surface of the dishwasher 100 (i.e., near the door 105 of the dishwasher 100). A more detailed, magnified view of a mounting bracket 200 on one side of a dishwasher 100 is provided in FIG. 2 (with the door of the dishwasher removed for unobstructed viewing). The structure and placement of a mounting bracket on the opposing side of the dishwasher would be expected to be substantially similar to that illustrated in FIG. 2.

As seen in FIG. 2, the side mounting bracket 200 is slidably engaged with a forward area of the dishwasher 100 via a corner support or receiving member 120. Such positioning allows for ease of attachment of the bracket 200 to the side attachment surface (e.g., a cabinet) when the dishwasher 100 is disposed in an installation position under a countertop. Moreover, since the frame members of a dishwasher are typically disposed near the front of the unit, a structurally sound mounting position for the corner support 120 may be provided. In the embodiment of FIG. 2, the corner support 120 is secured to the top brace 140 of the dishwasher 100 and is partially covered by the corner fascia 150.

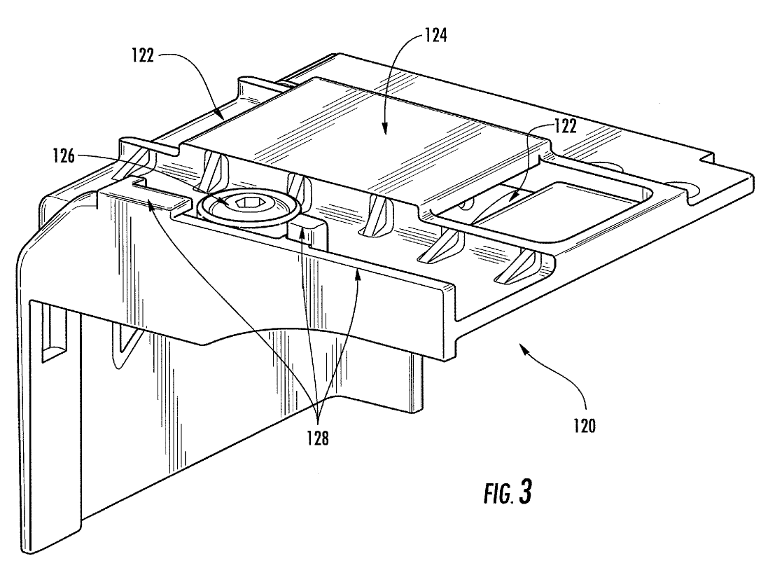

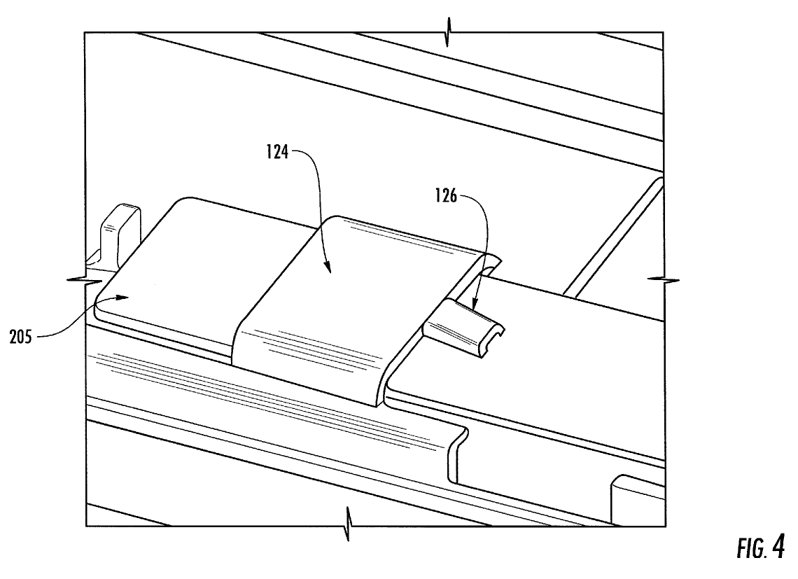

The corner support 120 can take on any configuration suitable for a receiving member that operably engages the dishwasher and slidably receives the mounting bracket 200. The corner support 120 may comprise, for example, metal, rigid plastic, or any suitable material capable of imparting the necessary strength and durability to secure the dishwasher to a cabinet. A detailed, magnified view of one embodiment of the corner support 120 is provided in FIG. 3. In the illustrated embodiment, the corner support 120 comprises a channel 122 for receiving the arm portion of the mounting bracket 200. The channel 122 is partially covered by channel cover 124 that assists in maintaining and retaining the mounting bracket 200 in the corner support 120 (i.e., longitudinally constraining the mounting bracket 200). In certain embodiments, the corner support 120 and/or the channel cover 124 can further comprise a friction device 126 for hindering or limiting sliding movement of the mounting bracket 200 in the corner support. One embodiment of a friction device 126 is illustrated in FIG. 4 attached to the channel cover 124. Preferably, the friction device 126 does not prevent sliding movement of the mounting bracket 200 in the channel of the corner support, but provides friction sufficient to prevent unintentional movement of the mounting bracket 200, such as during shipping of the dishwasher.

As further seen in the embodiment of FIG. 3, the corner support 120 includes an aperture for attachment of the corner support 120 to the dishwasher frame. In FIG. 3, the aperture is covered by a screw 126, which illustrates one method for attaching the corner support 120 to the dishwasher 100. Of course, other methods for attaching the corner support to the dishwasher are also encompassed by embodiments of the invention. In certain embodiments, the corner support 120 may also comprise one or more elements 128 for facilitating attachment of the corner fascia 150 to the dishwasher. Such elements can comprise clips or other protrusions for snap-fitting the corner fascia 150 onto the corner support 120.

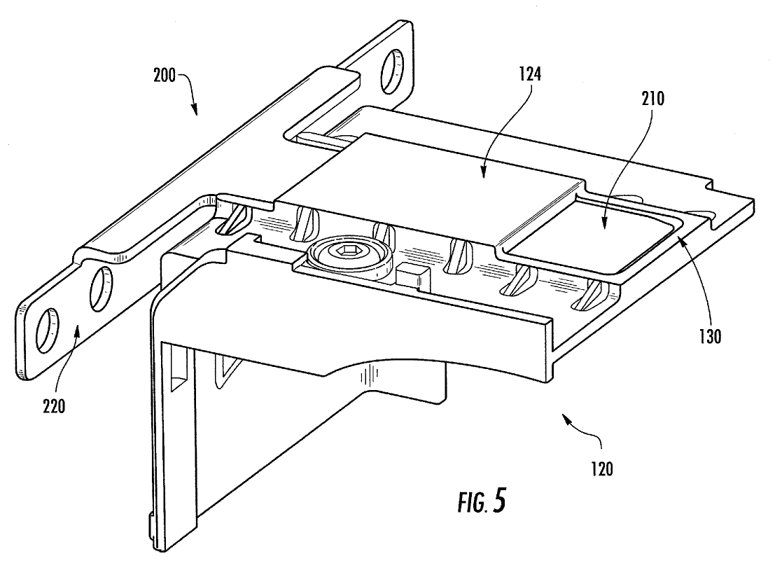

The corner support 120 is further illustrated in FIG. 5. The mounting bracket arm element 210 is slidably received by the channel of the corner support 120, and the channel cover 124 prevents the bracket arm element 210 from lifting out of the channel. As seen in FIGS. 4 and 5, the mounting bracket 200 is fully recessed into the channel of the corner support 120 such that the inwardly facing end 205 of the bracket arm element 210 is in contact with a channel stop 130, which functions to prevent contact of the mounting bracket 200 with the portions of the dishwasher 100 other than the corner support 120. The mounting bracket arm element 210 can thus move along the channel to slide laterally between an inward position (such as shown, for example, in FIG. 5) and an outward position, while being longitudinally constrained by the channel and the channel cover 124.

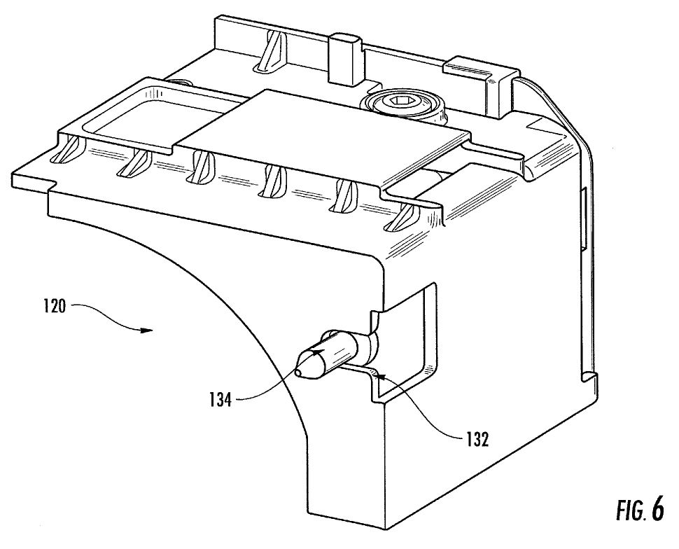

A rear view of the corner support 120 is provided in FIG. 6, which particularly illustrates a slot 132 in the corner support 120 for further attachment thereof to the top brace 140. In the embodiment of FIG. 6, a screw 134 extends through the slot 132 for attachment to the top brace 140. Of course, other methods of attachment are also encompassed by embodiments of the invention.

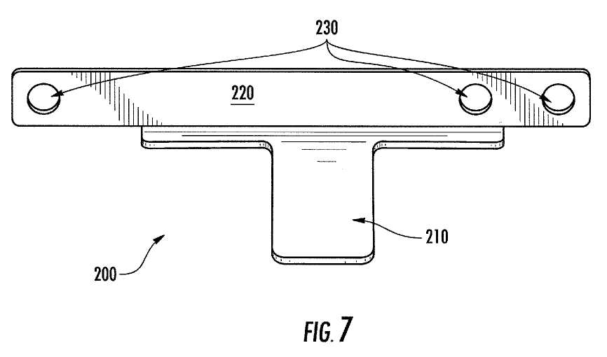

In some embodiments of the invention, the mounting brackets can be adjusted/oriented so as to provide a suitable or preferred securement of the dishwasher to the adjacent cabinets by allowing the fixation points to be selectively placed. One such embodiment of the mounting bracket 200 is shown in FIG. 7 and illustrates the mounting flexibility provided by embodiments of the invention. As seen in FIGS. 5 and 7, the mounting bracket includes an arm element 210 and a flange 220 formed opposite the laterally-inward end 205 of the arm element 210. Thus, the flange 220 is positioned to face laterally outward in relation to the corner support 120. As further shown, the arm element 210 may be configured to engage the flange 220 about one of the side edges of the flange 220, such that the flange 220 is essentially offset with respect to the arm element 210.

The flange 220 includes one or more fastening apertures 230 for securement of each mounting bracket 200 to the adjacent cabinet. The fastening apertures can be placed along the length of the flange 220 at varying positions as deemed most suitable for accommodating varying cabinet depths. Moreover, the flange 220 can engage the arm element 210 of the mounting bracket 200 such that the distance from the arm element 210 to one end of the flange is greater than the distance from the arm element 210 to the other end of the flange. In the embodiment of FIG. 7, for example, the flange 220 is unevenly spaced in relation to the arm element 210 such that the end of the flange 220 having a single fastening aperture 230 is longer than the end of the flange 220 having two fastening apertures 230.

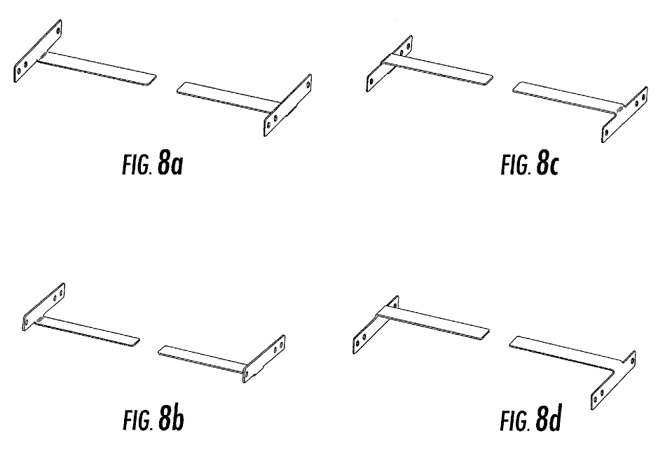

The mounting bracket is further useful in that it fully interchangeable (i.e., can be used on either lateral side, such as the left or right side, of the dishwasher). Further, in some instances, the arm element and the channel may be cooperatingly-configured such that the arm element is rotatable about an axis defined thereby so as to be capable of being received by the channel in different rotational positions, wherein each rotational position causes the flange to extend in a different direction from the axis of the arm element. Moreover, the bracket can be positioned on the left or right side, in the up or down position, to mount the dishwasher at various depths in the cabinet opening and to accommodate cabinets of varying heights. That is, the mounting brackets may be oriented “high” (flanges extending upwardly) to accommodate taller cabinets or “low” (flanges extending downwardly) to accommodate shorter cabinets. In other embodiments, as described above in relation to FIG. 7, the flanges may have different lengths in a fore/aft direction, which may allow the securement points to be either “close to” the dishwasher unit (e.g., for less deep cabinets where the mounting point is closer to the unit) or “far from” the dishwasher unit (e.g., for deeper cabinets where the unit may be inset further from the front of the cabinet). These varying bracket positions are illustrated in FIG. 8, where FIG. 8a illustrates a high and far from unit configuration, FIG. 8b illustrates a high and close to unit configuration, FIG. 8c (also FIG. 2) illustrates a low and close to unit configuration, and FIG. 8d (also FIG. 5) illustrates a low and far from unit configuration.

Thus, the dishwasher can be mounted under a countertop, without direct attachment to the countertop, by attaching the dishwasher to the laterally-adjacent cabinets via the bracket and receiver system described above. Moreover, the mounting brackets and related hardware used in the securement of the dishwasher to the cabinets are concealed by the dishwasher door when the door is in the closed position.

Many modifications and other embodiments of the inventions set forth herein will come to mind to one skilled in the art to which these inventions pertain having the benefit of the teachings presented in the foregoing descriptions and the associated drawings. For example, while the foregoing mounting system has been described in relation to a dishwasher, it is understood that such a mounting system could be further adapted for use with one or more additional appliances. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for the purposes of limitation.

That which is claimed:

1. An under-counter appliance mounting system comprising:
a pair of discrete bracket members each configured to be slidably received by a receiving member operably engaged with an appliance about a forward portion thereof, the receiving members being disposed in opposing lateral relation with respect to the forward portion of the appliance and configured such that the bracket members are laterally slidable between an inward position and an outward position, while being longitudinally constrained, each bracket member including a longitudinally-extending flange disposed outwardly of the respective receiving member, the flange defining at least one fastening aperture and being adapted to facilitate securement of the bracket member to a laterally-adjacent vertical surface via the at least one fastening aperture.

2. A system according to claim 1, wherein each bracket member comprises an arm element extending from the flange, the arm element being configured to be received within a channel defined by the respective receiving member.

3. A system according to claim 2, wherein the flange includes opposed ends and is configured to engage the arm element such that a distance from one end of the flange to the arm element is greater than a distance from the other end of the flange to the arm element.

4. A system according to claim 3, wherein the flange further includes opposed edges generally perpendicularly disposed with respect to the ends thereof, the arm element being configured to engage one of the edges of the flange.

5. A system according to claim 2, further comprising a channel cover configured to operably engage at least one of the receiving members so as to at least partially cover the channel, the channel cover cooperating with the receiving member to retain the corresponding bracket member within the channel.

6. A system according to claim 4, further comprising a friction device operably engaged with at least one of the channel cover and the receiving member, the friction device being configured to engage the corresponding arm element of the bracket member for limiting sliding movement of the bracket member received within the channel.

7. A system according to claim 1, wherein the arm element and the channel are cooperatingly-configured such that the arm element is rotatable about an axis defined thereby so as to be capable of being received by the channel in different rotational positions, each rotational position causing the flange to extend in a different direction from the axis.

8. A method for securing an appliance, under a countertop, to laterally-adjacent mounting surfaces, without direct attachment to the countertop, the method comprising:
slidably receiving a bracket member in each of a pair of discrete receiving members, the receiving members being operably engaged with an appliance about a forward portion thereof, and being disposed in opposing lateral relation with respect to the forward portion of the appliance, such that the bracket members are laterally slidable between an inward position and an outward position with respect thereto, while being longitudinally constrained, wherein each bracket member further includes a longitudinally-extending flange disposed outwardly of the respective receiving member; and
securing each bracket member to the laterally-adjacent mounting surface by engaging the mounting surface, via at least one fastening aperture defined by the flange, with a fastener.

9. A method according to claim 8, wherein each bracket member comprises an arm element extending from the flange, and slidably receiving a bracket member further comprises slidably receiving the arm element of the bracket member within a channel defined by the respective receiving member.

10. A method according to claim 9, further comprising operably engaging a channel cover with at least one of the receiving members so as to at least partially cover the channel and retain the corresponding bracket member within the channel.

11. A method according to claim 10, further comprising limiting sliding movement of the bracket member received within the channel with a friction device operably engaged with at least one of the channel cover and the receiving member, and configured to engage the corresponding arm element of the bracket member.

12. A method according to claim 8, further comprising rotating the arm element about an axis defined thereby such that the arm element is received by the channel in different rotational positions, each rotational position causing the flange to extend in a different direction from the axis.
